(19) United States
(12) Patent Application Publication
(10) Pub. No.: US 2010/0134934 A1
(43) Pub. Date: Jun. 3, 2010

(54) STARTER MOTOR CONTROL CIRCUIT

(75) Inventors: Morihiko Matsubara, Tokyo (JP); Yasuhiro Ueno, Osaka (JP); Seiji Hiraoka, Hyogo (JP)

Correspondence Address: DARBY & DARBY P.C., P.O. BOX 770, Church Street Station, New York, NY, 10008-0770, US

(73) Assignees: Shin Caterpillar Mitsubishi Ltd., Tokyo (JP); New Era Co., Ltd., Osaka (JP); Tomoe System Inc., Kobe (JP)

(21) Appl. No.: 12/063,274

(22) PCT Filed: Jul. 2, 2007
(86) PCT No.: PCT/JP2007/063217

§ 371 Date: Feb. 8, 2008

(30) Foreign Application Priority Data
Sep. 12, 2006 (JP) 2006-246415

(51) Int. Cl. H02H 3/16

(52) U.S. Cl. 361/49

(57) ABSTRACT

Provided is a starter motor control circuit capable of easily preventing the induction of a short-circuit current due to a ground fault in the power source line of a starter motor, in which a high current flows. A key switch (13) is connected with a battery (11), and a starter motor starting signal line (19) of a starter motor (18) is connected through a starter relay (16) with a start (ST) of the key switch (13). A protect relay (22) is disposed in a battery line (21) between the battery (11) and the starter motor (18). A ground fault detecting line (24) for detecting the ground fault of the battery line (21) is disposed between the battery line (21) and a controller (14). The controller (14) has a function to restrict the connecting actions of the starter relay (16) and the protect relay (22) when the ground fault of the battery line 21 is detected by a ground fault line (24), even if the key switch (13) is changed to the start (ST).

This is a U.S. national phase application under 35 U.S.C. §371 of International Patent Application No. PCT/JP2007/063217 filed Jul. 2, 2007, and claims the benefit of Japanese Application No. 2006-246415, filed Sep. 12, 2006. The International Application has not been published at the time of this filing. The contents of both applications are incorporated herein in their entirety.

### TECHNICAL FIELD

The present invention relates to a starter motor control circuit that controls starting/stoppage of a starter motor of an engine.

### BACKGROUND ART

There is a starter motor power supply circuit that includes: a power supply for a starter motor for an internal combustion engine; a main switch; a first relay switch, operating in conjunction with the main switch and controlling current supply to the internal combustion engine starter motor; a circuit breaker, disposed between the power supply and the internal combustion engine starter motor; a second release switch, making the current bypass the circuit breaker; and a controller, switching on the first relay switch when the main switch is switched on, switching off the first relay switch when the main switch is switched off, and switching on the second relay switch when the first relay switch is on; and is enabled to prevent degradation of an electrical apparatus or a circuit due to short circuiting without unnecessarily disconnecting the circuit breaker (see Japanese Laid-open Patent Publication No. 2002-115634 (page 1, FIG. 1)(“JP '634”)).

There is also an advance diagnostic device, in which a wiring leading from a battery to a starter motor is constituted of: a battery wiring, electrically connecting the battery and the starter motor; an inner insulating material, covering the battery wiring; a shield wire, wired at an outer side of the inner insulating material; and an outer insulating material, covering the shield wire; and arrangements are made to enable short circuiting of the battery wiring to be diagnosed in advance by detection of short circuiting of the shield wire accompanied by breakage of the outer insulating material and thereby enable short circuiting of the battery wiring, which supplies power to an electrical component, to be diagnosed in advance (see Japanese Laid-open Patent Publication No. 2002-247753 (page 1, FIG. 1)(“JP '753”)).

In a construction machine, because a large current flows to a starter motor, short circuit protection by a circuit breaker, fuse, or other devices could not be implemented readily.

For example, with the power supply circuit described in JP'634, the respective internal resistances of the bypass relay and the circuit breaker do not greatly differ and thus while cranking, a large current of approximately 1000 to 1500 A flows into the circuit breaker as well, causing the circuit breaker to unnecessarily trip. A bypass relay that is sufficiently low in internal resistance in comparison to a circuit breaker is difficult to manufacture. Although placing a resistor in series in the circuit breaker line can be considered as a countermeasure, this leads to enlargement of the circuit breaker.

With the diagnostic device described in JP '753, although short circuiting of the shield wire due to biting of a metal object into the wiring from the battery to the starter motor can be detected in advance, unless treatment is performed within a short time, the metal object that is bitten into the cable may reach the core wire and cause short circuit of the core wire.

The present invention has been made in view of the above points, and an object thereof is to provide a starter motor control circuit that can readily prevent the occurrence of a short circuit current due to a ground fault in a power supply line of a starter motor, through which a large current flows.

### SUMMARY OF THE INVENTION

According to the present invention, there is provided a starter motor circuit including: a switch, connected to a power supply and enabling switching among on, off, and start positions; a starter relay, having a normally open contact disposed between the start position of the switch and a starter motor starting signal line of a starter motor for starting an engine; a protection relay, having a normally open contact disposed in a power supply line between the power supply and the starter motor; and a controller, having a function of detecting a ground fault of the power supply and thereby restricting connection operations of the starter relay and the protection relay even when the switch is switched to the start position.

According to the present invention, the controller in the starter motor control circuit according to the above has a function of connecting the protection relay before connecting the starter relay in accordance to the switching of the switch to the start position and disconnecting the protection relay after disconnecting the start relay.

According to the present invention, the starter motor control circuit according to the above furthermore includes a monitor, performing a warning display of a ground fault of the power supply line.

According to the present invention, because instead of performing an action, such as circuit disconnection, etc., after detection of a short circuit current, the power supply line of the starter motor, through which a large current flows, is disconnected in advance by the protection relay and the controller connects the protection relay only while cranking for starting the starter motor, even if a ground fault of the power supply line occurs at times other than while cranking, generation of a short circuit current can be prevented readily by the protection relay.

According to the present invention, because while cranking, the controller shifts the connection timings of the starter relay and the protect relay so that the protection relay is connected before connecting the starter relay and the protection relay is disconnected after the starter relay is disconnected, opening and closing operations of the protection relay contact can be performed in a state in which the starter relay is disconnected and a large current is not flowing, thus enabling a contact current capacity of the protection relay to be made larger than a rated value and enabling accommodation by a comparatively small relay.

According to the present invention, the controller has detected and is ascertaining a ground fault can be displayed as a warning on the monitor to instruct repair treatment of the ground fault.

### BRIEF DESCRIPTION OF THE DRAWINGS

FIG. 1 is a circuit diagram of an embodiment of a starter motor control circuit according to the present invention.

FIG. 2 is a time chart of a control procedure of respective portions of the same circuit above.

### DETAILED DESCRIPTION OF THE INVENTION

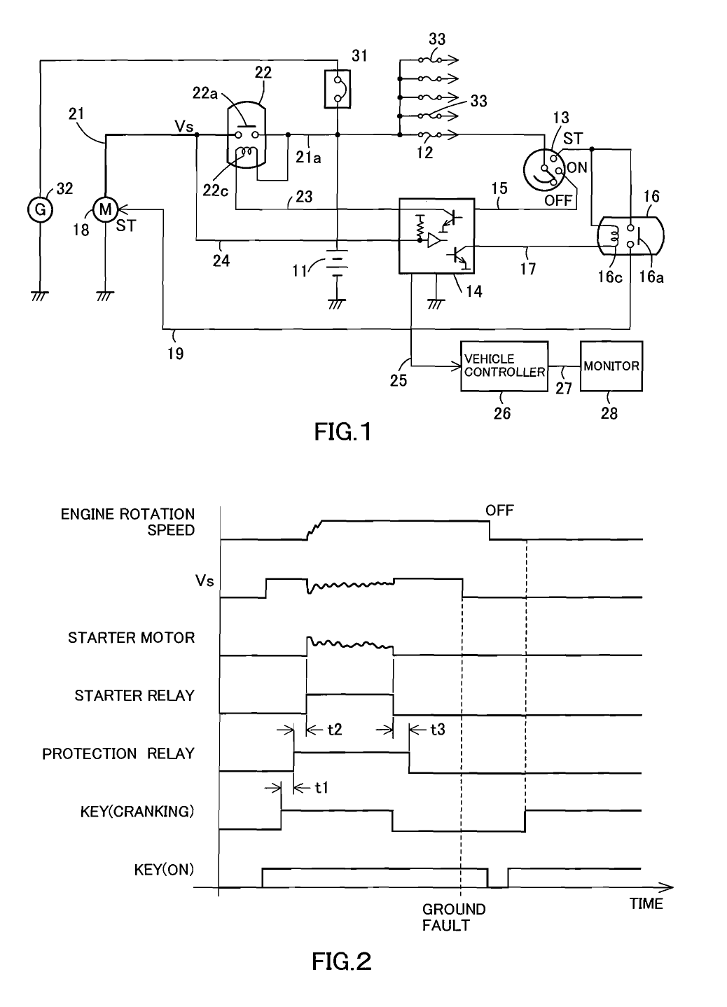

The present invention shall be described in detail with reference to an embodiment illustrated in FIGS. 1 and 2 as follows.

FIG. 1 shows a starter motor control circuit that starts and controls an engine installed in a vehicle of a working machine, such as a hydraulic shovel, etc., and a key switch 13, functioning as a switch, is connected via a fuse 12 to a battery 11, functioning as a power supply. The key switch 13 has: an off switch position; an ON switch position, with which connection is made to a controller 14 via a switch position detection line 15; and a start ST switch position for engine cranking; and enables switching among these positions.

A starter relay 16 is connected to the start ST of the key switch 13. The starter relay 16 has a coil 16c, connected by a starter relay exciting line 17 to the start ST of the key switch 13 and to the controller 14, and a normally open contact 16a, connected by excitation of the coil 16c, and the normally open contact 16a is connected to the start ST of the key switch 13 and to a starter motor starting signal line 19 of a starter motor 18 for starting the engine.

A protection relay 22 is disposed in a battery line 21, functioning as a power supply line between the battery 11 and the starter motor 18. The protection relay 22 has a coil 22c, connected by a protection relay exciting line 23 to an upstream battery line 21a and to the controller 14, and a normally open contact 22a, connected by excitation of the coil 22c.

A ground fault detection line 24 for detection of a ground fault of the battery line 21 is disposed between the battery line 21 and the controller 14.

Upon detecting a ground fault of the battery line 21 by means of the ground fault detection line 24, the controller 14 functions to restrict connection operations of the starter relay 16 and the protection relay 22 even when the key switch 13 is switched to the start ST.

The controller 14 furthermore has a function of connecting the protection relay 22 before connecting the starter relay 16 in accordance with the switching of the key switch 13 to the start ST and disconnecting the protection relay 22 after disconnecting the starter relay 16.

The controller 14 is connected through a communication unit 25 to a vehicle controller 26 and is connected from the vehicle controller 26 to a monitor 28 through a communication unit 27. The monitor 28 is installed at a position visible to an operator inside a cab of a working machine, etc., and performs a warning display of a ground fault occurring in the battery line 21.

The battery 11 is also connected via a circuit breaker 31 to an alternator 32 and to respective loads and circuits via fuses 33 as well.

Operations and effects of the present embodiment shall be described bellow.

As shown in FIG. 2, when the key switch 13 is set through the ON position to the start ST position (cranking), the controller 14 that has detected the start ST through the switch position detection line 15 waits for the elapse of a time t1 set in a built-in timer and thereafter energizes the coil and connects the contact of the protection relay 22, and furthermore after the elapse of a time t2 set in a built-in timer, energizes the coil and connects the contact of the starter relay 16 and thereby starts the starter motor 18 through the starter motor starting signal line 19.

In this process, a potential Vs at the battery line 21 and an engine rotation speed vary as shown in FIG. 2.

The controller 14 distinguishes between the start ST (cranking) and the ON positions based on the contact structure of the key switch 13, and when the key switch 13 is returned to the ON position from the start ST (cranking) position, the contact of the starter relay 16 is disconnected, the starter motor 18 is stopped, and after the elapse of a time t3, set in a built-in timer, from the disconnection of the contact of the starter relay 16, the controller 14 stops energizing the coil and disconnects the contact of the protection relay 22.

Although when a ground fault occurs in the battery line 21, the potential Vs drops to a ground level, even if a ground fault occurs in the battery line 21 after starting, because the battery line 21 is disconnected by the protection relay 22, short circuiting of the battery line 21 does not occur.

After the ground fault, even if the key switch 13 is switched from ON to OFF to stop engine rotation and then the key switch 13 is switched from ON to the start ST (cranking) position for restarting, the controller 14 that has detected the ground fault through the ground fault detection line 24 keeps the starter relay 16 and the protection relay 22 in the disconnected state and thus the starter motor 18 is not started.

Because the battery line 21 remains disconnected by the protection relay 22, protection is provided in likewise manner even if a ground fault occurs before starting.

Because instead of performing circuit disconnection or other upon detection of a short-circuit current, the battery line 21 of the starter motor 18 is disconnected by the protection relay 22 at times unless while cranking and connection is made only while cranking for starting the starter motor 18, even if short circuiting of the battery line 21 occurs, the generation of a short circuit current can be prevented.

Furthermore, by the controller 14 performing control so that while cranking, the protection relay 22 is connected before connection of the starter relay 16, and so that the protection relay 22 is disconnected after the starter relay 16 is disconnected, opening and closing operations of the contact of the protection relay 22 can be performed in a state in which the starter relay 16 is disconnected and a large current is not flowing.

That is, because the opening/closing timings of the starter relay 16 and the protection relay 22 are shifted so that the contact of the protection relay 22 is opened and closed when the cranking current is not flowing through the starter relay 16, the contact current capacity of the protection relay 22 can be made greater than a rated current value and accommodation by a comparatively small relay is enabled. Here, the rated current is a contact current capacity at which direct cutoff and conduction of a load current are enabled.

Also, the ground fault detection line 24 for detection of a ground fault by the controller 14 is disposed in the battery line 21 and because when, after the key switch 13 is switched on, a ground fault of the battery line 21 occurs, the potential Vs changes to the ground level, the operation of the starter relay 16 can be restricted and the connection of the starter relay 16 can be prevented by detecting the ground fault by means of the ground fault detection line 24.

Because the controller 14 is connected to the vehicle controller 26 and furthermore to the monitor 28, a signal can be issued to the vehicle controller 26 and the vehicle controller 26 can thereby perform a warning display on the monitor 28, etc.

Even when short circuiting of the battery line 21 occurs after starting of the engine, because the contact of the protection relay 22 is disconnected, a short circuit current does not flow, and that the controller 14 has detected and is ascertaining the ground fault can be displayed as a warning on the monitor 28 to instruct repair treatment of the ground fault.

Furthermore, even when the engine is stopped and then cranking is performed again with the ground fault being left unrepaired, because the contact of the protection relay 22 remains disconnected in accordance with the ground fault detection by the controller 14, a ground fault accident does not occur. Contents of the repair treatment of the ground fault can be displayed as a warning on the monitor 28.

Thus a decisive difference with respect to short circuit protection by a circuit breaker or fuse is that instead of performing an action, such as circuit disconnection, etc., after detection of a short circuit current, the battery line 21 of the starter motor 18, through which a large current flows, is disconnected in advance by the protection relay 22 and the controller 14 connects the protection relay 22 only while cranking for starting the starter motor 18, and thus even if a ground fault of the battery line 21 occurs at times other than while cranking, the generation of a short circuit current can be prevented readily by the protection relay 22.

Also with protection by a fuse or circuit breaker, because an action is taken after detection of a short circuit, a short circuit state occurs and a large current flows inevitably, even for a short time. In contrast, with the present invention, the protection relay 22 enables no short circuit current to flow whatsoever even when a short circuit occurs.

The present invention can be used, for example, in a vehicle installed in a working machine, such as a hydraulic shovel, etc.

1. A starter motor circuit comprising:
a switch, connected to a power supply and enabling switching among ON, OFF, and start positions;
a starter relay, having a normally open contact disposed between the start position of the switch and a starter motor starting signal line of a starter motor for starting an engine;
a protection relay, having a normally open contact disposed in a power supply line between the power supply and the starter motor; and
a controller, having a function of detecting a ground fault of the power supply and thereby restricting connection operations of the starter relay and the protection relay even when the switch is switched to the start position.

2. The starter motor control circuit according to claim 1, wherein the controller has:
a function of connecting the protection relay before connecting the starter relay in accordance to the switching of the switch to the start position and disconnecting the protection relay after disconnecting the start relay.

3. The starter motor control circuit according to claim 1, further comprising:
a monitor, performing a warning display of a ground fault of the power supply line.
